(19) United States
(12) Patent Application Publication
(10) Pub. No.: US 2016/0348983 A1
(43) Pub. Date: Dec. 1, 2016

(54) HEAT EXCHANGE APPARATUS

(71) Applicant: SunEdison, Inc., Maryland Heights, MO (US)

(72) Inventors: Peter Spicka, Bettendorf, IA (US); Puneet Gupta, Singapore (SG)

(73) Assignee: SUNEDISON, INC., Maryland Heights, MO (US)

(21) Appl. No.: 14/723,572

(22) Filed: May 28, 2015

(51) Int. Cl. F28D 7/10; B01J 8/24; C01B 33/027; F28F 27/00

(52) U.S. Cl. CPC F28D 7/106; F28F 27/00; B01J 8/24; C01B 33/027; B01J 2208/00221

(57) ABSTRACT

Heat exchange apparatus and, particularly, heat exchangers having a baffled cooling jacket are disclosed. Methods for using the exchangers including methods that involve cooling an effluent gas produced from a fluidized bed reactor for producing polycrystalline silicon are also disclosed.

### FIELD OF THE DISCLOSURE

The field of the disclosure relates to heat exchange apparatus and, particularly, to heat exchangers having a baffled cooling jacket. The field of the disclosure also relates to methods for using the exchangers including methods that involve cooling an effluent gas produced from a fluidized bed reactor for producing polycrystalline silicon.

### BACKGROUND

Various reactor systems involve preparation of high temperature gaseous products and/or effluents. Such high temperature streams may be cooled to allow the gaseous process streams to be filtered to remove particulate material from the streams. Exemplary systems in which a high temperature effluent is produced include preparation of polycrystalline silicon by pyrolysis of thermally decomposable silicon-containing compounds (e.g., silane, trichlorosilane or dichlorosilane). The gaseous effluent may include amounts of a carrier gas (e.g., hydrogen, silicon tetrachloride or argon), unreacted thermally decomposable silicon-containing compounds and silicon dust or “fines”. Typically the effluent is cooled before such silicon dust or fines are removed to prevent damage to the filter materials.

A continuing need exists for reactor and/or heat exchange systems that allow process gases to be quickly and efficiently cooled while minimizing the overall exchanger height and pressure drop. A need exists for systems that reduce internal erosion that leads to contamination and minimize particle sedimentation and/or pluggage from carry-over from upstream reactor operations. A continuing need also exits for methods that involve use of such heat exchangers and/or reactors.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the present disclosure is directed to a heat exchange apparatus for transferring heat between a first process stream and a second process stream. The exchanger includes a shell and a tube within the shell. The tube has a vertical portion and a horizontal portion transverse to the vertical portion. The shell and tube form an annular chamber between the shell and tube. The exchanger includes a baffle within the annular chamber.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a front view of the heat exchange apparatus;

FIG. 2 is a front view of the heat exchange apparatus with the shell omitted for clarity;

FIG. 3 is a perspective cross-section view of the heat exchange apparatus showing a helical baffle therein;

FIG. 4 is a front cross-section view of the heat exchange apparatus showing a protective liner in the vertical portion of the tube;

FIG. 5 is a schematic of a system for producing polycrystalline silicon including the heat exchange apparatus;

FIG. 6 is a contour map of the back of the heat exchange apparatus showing erosion rates during use;

FIG. 7 is a temperature contour profile map of the gaseous effluent cooled in the heat exchange apparatus according to Example 2; and

FIG. 8 is a temperature contour profile map of the cooling water circulated through the heat exchange apparatus according to Example 2.

Corresponding reference characters indicate corresponding parts throughout the drawings.

### DETAILED DESCRIPTION

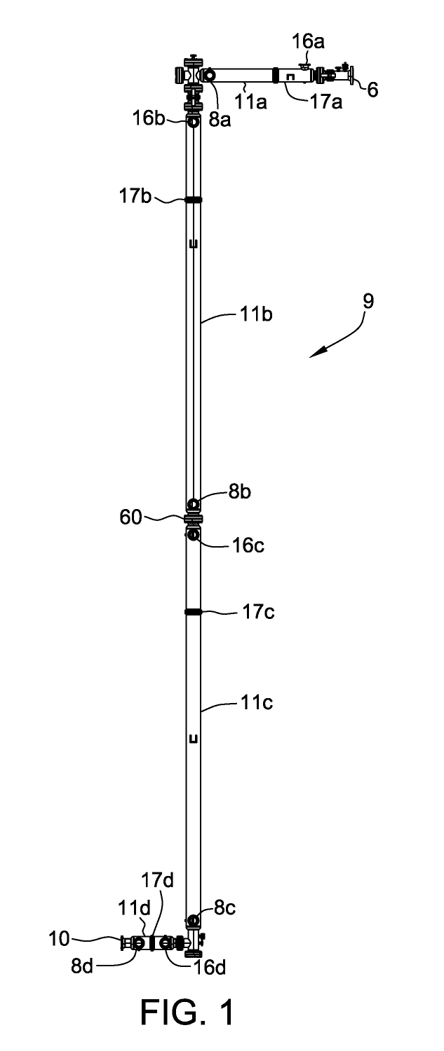

Referring now to FIG. 1, a shell and tube heat exchange apparatus 9 or “exchanger” for exchanging heat between two process streams in accordance with the present disclosure is shown. The heat exchange apparatus 9 includes a shell having a number of segments. The shell includes a first horizontal segment 11a and a second horizontal segment 11d. An upper vertical segment 11b and a lower vertical segment 11c are disposed between the first horizontal segment 11a and the second horizontal segment 11d. The two vertical segments 11b, 11c are each generally transverse to the two horizontal segments 11a, 11d. The upper vertical segment 11b is disposed between the first horizontal segment 11a and the lower vertical segment 11c and the lower vertical segment 11c is disposed between the upper vertical segment 11b and the second horizontal segment 11d.

While the various segments 11a, 11b, 11c, 11d may be referred to herein as being “vertical” or “horizontal”, these terms should not be considered in a limiting sense and are intended to include embodiments in which a segment forms an angle with the respective vertical or horizontal plane (e.g., an angle of less than about 45° with the plane). Further, the first horizontal segment 11a may be at an angle other than 90° with the upper vertical segment 11b and the lower vertical segment 11c may be at an angle other than 90° C. with the second horizontal segment 11d. For example, the lower vertical segment 11c may be at an angle of at least 30° C. with the second horizontal segment 11d or an angle of at least 40°, at least 60° or at least 80° (e.g., from about 30° to about 90°, from about 40° to about 90° or from about 60° to about 90° with the second horizontal segment 11d). Alternatively or in addition, the first horizontal segment 11a may be at an angle of at least 30° C. with the upper vertical segment 11d or an angle of at least 40°, at least 60° or at least 80° (e.g., from about 30° to about 90°, from about 40° to about 90° or from about 60° to about 90° with the upper vertical segment 11d).

Each segment 11a, 11b, 11c, 11d of the shell includes an inlet 8a, 8b, 8c, 8d for introducing a process stream (e.g., cooling fluid) and an outlet 16a, 16b, 16c, 16d for withdrawing the process stream. The shell segments 11a, 11b, 11c, 11d may be connected in parallel (e.g., process fluid from a common source is introduced into each segment). In other embodiments, the shell segments 11a, 11b, 11c, 11d or connected in series (e.g., outlet 16d may be in fluid communication with inlet 8c, outlet 16c may be in fluid communication with inlet 8b and outlet 16b may be in fluid communication with inlet 8a). Each segment 11a, 11b, 11c, 11d may include an expansion joint 17a, 17b, 17c, 17d (e.g., expansion bellows) to allow the tube segments to extend and retract with changes in temperature.

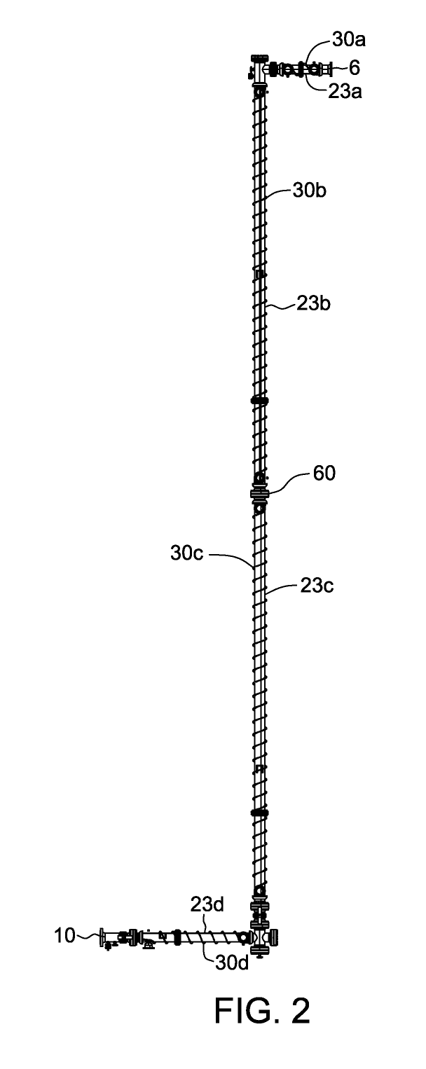

Referring now to FIG. 2, a tube having a first horizontal portion 23a, a second horizontal portion 23d, and a vertical portion having an upper segment 23b and lower segment 23c is disposed within the shell. The upper segment 23b and lower segment 23c are connected at a flanged joint 60. The upper segment 23b of the vertical portion of the tube is disposed between the first horizontal portion 23a and the lower segment 23c. The lower segment 23c is disposed between the upper segment 23b and the second horizontal portion 23d. While the upper segment 23b and the lower segment 23c of the vertical portion of the tube are described herein and illustrated in FIG. 2 as having a flanged joint 60 connecting the segments 23b, 23c, the segments 23b, 23c may be a continuous tube. In such embodiments, the upper segment 23b and lower segment 23c correspond to the segments of the vertical portion of the tube that are respectively jacketed by upper vertical shell section 11b and lower vertical shell section 11c as described further below.

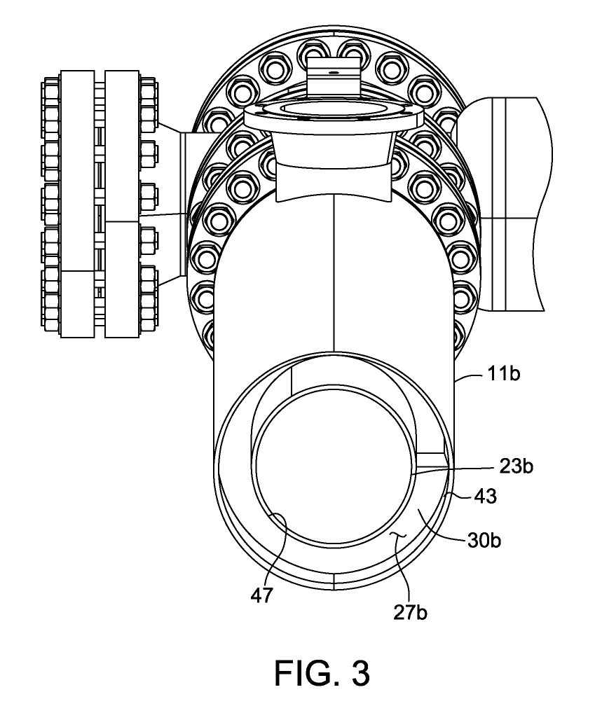

The first horizontal tube portion 23a is jacketed by the first horizontal shell section 11a (FIG. 1) and the second horizontal tube portion 23d is jacketed by the second horizontal shell section 11d. The upper segment 23b of the vertical portion of the tube is jacketed by the upper vertical section 11b of the shell. The lower segment 23c of the vertical portion of the tube is jacketed by the lower vertical section 11c of the shell. Each shell and tube segment defines an annular chamber 27a, 27b, 27c, 27d (chamber 27b defined between upper vertical section 11b of the shell and the upper segment 23b of the vertical portion of the tube being shown in FIG. 3). Helical baffles 30a, 30b, 30c, 30d (baffle 30b being shown in FIG. 3) extend within each annular chamber 27a, 27b, 27c, 27d. Each helical baffle 30a, 30b, 30c, 30d includes an outer edge 43 and an inner edge 47. The outer edge 43 contacts the respective shell section 11a, 11b, 11c, 11d and the inner edge 47 contacts the respective tube section 23a, 23b, 23c, 23d.

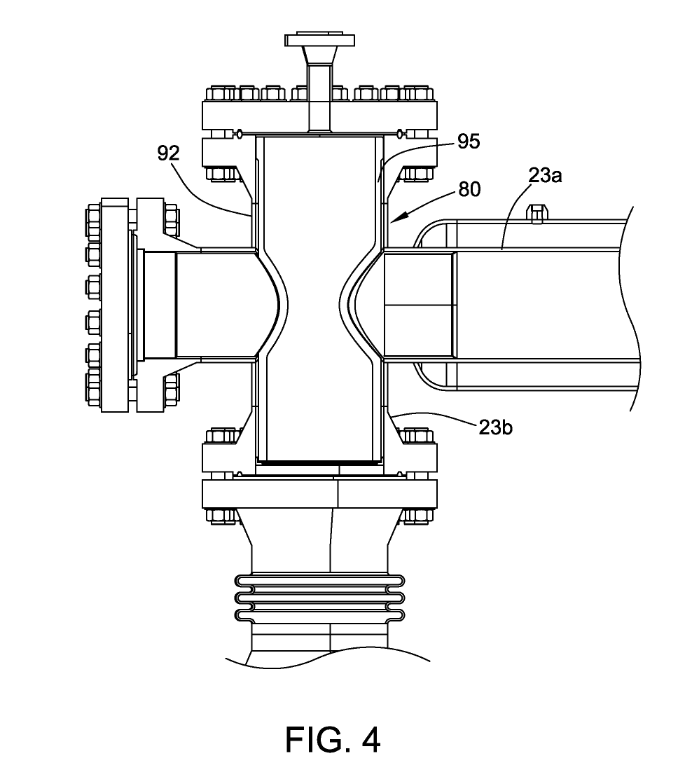

The first horizontal portion 23a of the tube and the upper section 23b of the vertical portion of the tube form a joint 80 (FIG. 4). At least one of the first horizontal portion 23a or upper section 23b of the vertical portion of the tube includes a substrate 92 (e.g., linear pipe section comprising stainless steel or carbon steel) and a protective liner 95 disposed on the substrate 92 for reducing erosion at the joint 80. As shown in FIG. 4, the protective liner 95 covers the inner surface of the upper section 23b of the vertical portion of the tube. The protective liner 95 may be composed of any material that is resistant to erosion caused by small particulate such as silicon fines. In some embodiments, the protective liner 95 comprises graphite, tungsten, carbide or cobalt-chromium alloys (e.g., STELLITE). The protective liner 95 may contain at least about 50 wt % of graphite, tungsten, carbide or cobalt-chromium alloys or at least about 75 wt %, at least about 95 wt % or consists essentially of graphite, tungsten, carbide or cobalt-chromium alloys. In some embodiments, the joint between the second horizontal section 23d and lower section 23c also includes a protective liner similar to liner 95.

In some embodiments (e.g., some embodiments in which the heat exchange apparatus is used to cool effluent gas from a fluidized bed reactor used to produce polycrystalline silicon from a thermally decomposable silicon-containing compound), the vertical portion of the tube (i.e., the upper section 23b and lower section 23c of the vertical portion of the tube) has an aspect ratio (ratio of length to diameter) between about 70 and about 110 or between about 80 and 100. Alternatively or in addition, the first horizontal portion 23a may have an aspect ratio between about 15 and about 45 or between about 20 and about 40. The tube may have a diameter from about 10 cm to about 50 cm. The shell may have a diameter from about 1 cm to about 15 cm greater than the diameter of tube or from about 2 cm to about 10 cm greater than the diameter of tube. The helical baffle sections 30a, 30b, 30c, 30d may have a pitch (i.e., ratio of the distance between flights to the tube diameter) of about 1 to about 2 or from about 1.25 to about 1.75. It should be noted that the recited aspect ratios, tube and shell sizes and baffle pitches are exemplary and other parameters may be used without departing from the scope of the present disclosure.

The materials of construction for the heat exchange apparatus 9 may be selected to be resistant to corrosion in an environment that includes exposure to the various fluids transferred and/or reacted therein. Suitable materials of construction are conventional and well-known in the field of the disclosure and include, for example, silicon carbide, stainless steel, INCONEL alloys and HASTELLOY alloys. In some embodiments, the protective liner 95 is composed of graphite, tungsten, carbide or cobalt-chromium alloys.

In this regard, it should be understood that while the shell and tube heat exchanger 9 and various corresponding parts are generally shown as being cylindrical, other arrangements may be used and the cylindrical arrangement should not be considered in a limiting manner. Further, it should be understood that the shell-side fluid may transfer heat to the tube-side fluid or the tube-side fluid may transfer heat to the shell-side fluid unless stated otherwise herein.

In operation of the heat exchange apparatus, a first fluid (e.g., a first process gas) may be introduced into the tube of the exchanger 9. A second fluid, third fluid, fourth fluid and fifth fluid are introduced, respectively, into the various sections 11a, 11b, 11c, 11d of the shell of the exchanger (i.e., the chamber formed between the tube and each shell section). Generally the second, third, fourth and fifth fluids are liquids and may be distributed from the same source (e.g., cooling water). The shell-side fluids are each forced through the flights of the helical baffle 30a, 30b, 30c, 30d to cause the fluid to circulate around the tube.

As shown in FIG. 2, the first fluid enters the exchanger 9 at the first horizontal portion 23a of the tube at a tube-side inlet 6 and exits through the bottom of the exchanger 9 through a tube-side outlet 10 attached to the second horizontal portion 23d. The shell-side fluids enter each shell section 11a, 11b, 11c, 11d (FIG. 1) through inlets 8a, 8b, 8c, 8d and exit through outlets 16a, 16b, 16c, 16d. It should be understood that other arrangements may be used without limitation. The first process stream and shell-side process streams generally flow in a countercurrent arrangement as they pass through the shell and tube heat exchanger 9; however, it should be understood that other flow patterns (concurrent flows) may be used without limitation.

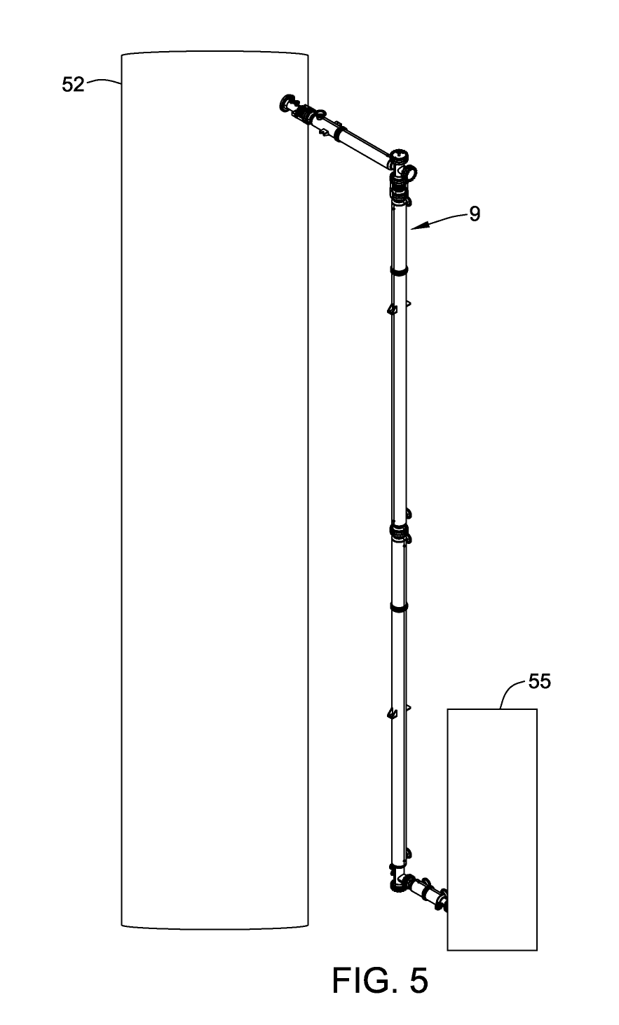

In some embodiments, the heat exchange apparatus 9 forms part of a system for producing polycrystalline silicon. The system may include the various process streams within the various components of the system during steady-state operation. The shell and tube heat exchange apparatus 9 may be in fluid communication with a reactor apparatus 52 (FIG. 5) such as a fluidized bed reactor to allow the first process stream to be cooled before entering the downstream filter assembly 55 for removing particulate fines from the first process stream. The filter assembly 55 is in fluid communication with the heat exchange apparatus 9 through the tube-side outlet 10 (FIG. 1) of the exchanger. As described herein, the reactor effluent (or product depending on the reaction) is introduced into the tube-side of the exchanger 9 where it exchanges heat with the shell-side fluids that circulate through the shell sections 11a, 11b, 11c, 11d of the exchanger 9. In some embodiments, the second, third, fourth and fifth process fluids are a cooling fluid (e.g., cooling water). The exchanger 9 may be used in other reactor and processing arrangements.

Optionally, the reactor apparatus 52 of FIG. 5 may be used to produce polycrystalline silicon from a thermally decomposable silicon-containing compound by a chemical vapor deposition process. Silicon is deposited from the thermally decomposable silicon compound onto silicon particles in the fluidized bed reactor. The seed particles continuously grow in size until they exit the reactor as polycrystalline silicon product (i.e., “granular” polycrystalline silicon). Suitable decomposable silicon compounds include, for example, silane and halosilanes such as dichlorosilane and trichlorosilane.

The thermally decomposable silicon-containing compound and carrier gases (e.g., hydrogen, silicon tetrachloride and/or argon) are introduced into the fluidized bed reactor 52 in which it fluidizes growing silicon seed particles to produce polycrystalline silicon which may be withdrawn from the reactor as polycrystalline silicon product. The effluent may be at a temperature of at least 500° C., at least about 550° C., at least about 600° C., at least about 650° C. or even at least about 700° C. The effluent may include at least about 0.0001% silicon fines by volume or at least about 0.0050 or about 0.01% silicon fines by volume or more. The silicon fines may have a nominal diameter of at least about 1 μm, at least about 5 μm, at least about 10 μm, at least about 50 μm, or even at least about 75 μm (e.g., from about 1 μm to about 100 μm).

The mass ratio of cooling fluid (e.g., cooling tower water) introduced into each shell-side section 11a, 11b, 11c, 11d to the amount of tube-side gas may be at least about 100:1, at least about 150:1 or at least about 200:1 (e.g., from about 100:1 to about 300:1 or from 150:1 to 250:1). Such flow rates may prevent localized boiling at a reasonable pressure drop with minimal difference in the respective shell-side inlet 8a, 8b, 8c, 8d and outlet 16a, 16b, 16c, 16d temperatures (e.g., less than about 10° C.) as described in Example 2 below. Such pressure drop may be less than about 750 kPa (excluding hydrostatic drop) or even less than about 500 kPa. The recited flow rates may also result in the effluent being cooled by the heat exchange apparatus 9 to less than about 200° C., less than about 175° C. or even less than about 150° C. before entering the filter assembly 55. The heat exchanger may cool the effluent by at least about 200° C., at least about 250° C., at least about 300° C., at least about 350° C., at least about 400° C. or even about 500° C. or more.

The fluidized bed reactor may be operated at relatively high pressure (e.g. at least about 3 bar and up to about 25 bar); however higher pressures may be less desirable as such pressures may involve relatively high application of extraneous heat (e.g., higher temperatures) through the reactor walls and may result in an unacceptable amount of silicon deposition on the reactor walls. In certain embodiments, the pressure of the reactor is controlled to be at least about 4 bar, at least about 5 bar, at least about 10 bar, at least about 15 bar, at least about 20 bar or even about 25 bar or more (e.g., from about 3 bar to about 25 bar or from about 4 bar to about 20 bar). The throughput of effluent gas to the exchanger 9 as expressed per tube-side cross-section area may be at least about 15,000 kg/hr/m², at least about 20,000 kg/hr/m², at least about 25,000 kg/hr/m² or even at least about 30,000 kg/hr/m² (e.g., from about 15,000 kg/hr/m² to about 40,000 kg/hr/m² or from about 20,000 kg/hr/m² to about 35,000 kg/hr/m²).

In embodiments in which silane is used as the thermally decomposable compound, the reactor may be operated in accordance with the reaction conditions disclosed in U.S. Patent Publication No. 2013/0084233, which is incorporated herein by reference for all relevant and consistent purposes. In embodiments in which dichlorosilane is used as the thermally decomposable compound, the reactor may be operated in accordance with the reaction conditions disclosed in U.S. Patent Publication No. 2012/0164323, which is incorporated herein by reference for all relevant and consistent purposes. In embodiments in which trichlorosilane is used as the thermally decomposable compound, the reactor may be operated in accordance with the reaction conditions disclosed in U.S. Patent Publication No. 2012/0100059, which is incorporated herein by reference for all relevant and consistent purposes.

In embodiments in which the effluent from a fluidized bed reactor for producing polycrystalline silicon is cooled with cooling water, the heat exchanger may provide a heat flux of at least about 25 KW /m² or at least about 35 KW/m² or even 45 KW/m². The geometry of the exchanger 9 (i.e., use of vertical and horizontal portions) may allow the reactor to be used in relatively compact spaces. In some embodiments, the ratio of the height of the fluidized bed reactor 52 (e.g., distance from the input of gas into the reactor and the effluent gas outlet) to the height of the exchanger 9 is less than about 1.5, less than about 1.35, less than about 1.15 or even less than about 1.

Compared to conventional apparatus for exchanging heat, the heat exchange apparatus 9 described above has at least several advantages. In embodiments in which a single tube is used and in which process streams containing silicon fines are introduced in the tube-side of the exchanger, relatively high throughput may be achieved with reduced sedimentation or pluggage on the tube-side. Use of a protective liner 95 (FIG. 4) may reduce erosion in the exchanger 9. Use of horizontal and vertical sections of the shell and tube allow the exchanger to be relative compact and/or to have a length that is not substantially greater than the fluidized bed reactor in which the effluent gas is produced. Use of helical baffles 30a, 30b, 30c, 30d at the recited pitch improves the rate of heat transfer and prevents localized boiling of the cooling fluid.

### EXAMPLES

The processes of the present disclosure are further illustrated by the following Examples. These Examples should not be viewed in a limiting sense.

### EXAMPLE 1

### Simulation of the Erosion Rate in the Heat Exchange Apparatus

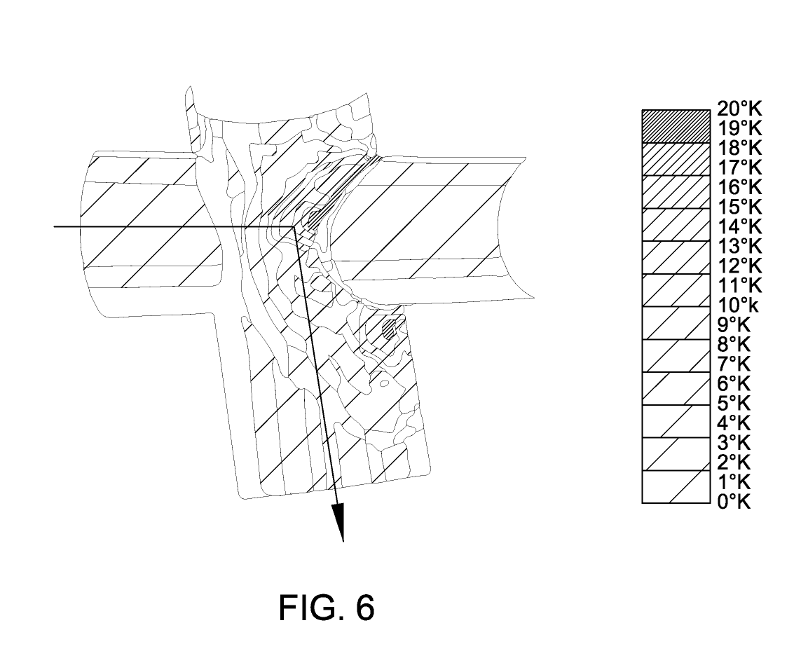

The rate of erosion in a heat exchange apparatus composed of grade 316 stainless steel for quench cooling the effluent from a fluidized bed reactor for producing polycrystalline from silane was simulated using computational fluid dynamics (ANSYS Fluent). The effluent from the reactor included 0.2 volt silicon fines (about 10 wt %). The erosion rate of the tube at the joint between the first horizontal portion 23a (FIG. 2) and upper segment 23b of the vertical portion is shown in FIG. 6. The arrow indicates the direction of flow of the tube-side gas. As may be seen from FIG. 6, the erosion rate is high at the top of the vertical section of the tube (e.g., as high as 70 μm/year). The erosion rate may be reduced by use of protective liner 95 (FIG. 4).

### EXAMPLE 2

### Simulation of the Temperature Change in the Heat Exchange Apparatus

The heat exchange rates of the exchanger of Example 1 were also simulated. The exchanger was simulated at a gas flow rate of 9,356 kg/hr per m² of reactor cross-sectional area and a silicon fines rate of 1,139 kg/hr per m² of reactor cross-sectional area. The heat exchanger included a single jacket (or a series of jackets connected in series) with cooling water circulating shell-side concurrent to the flow of effluent gas.

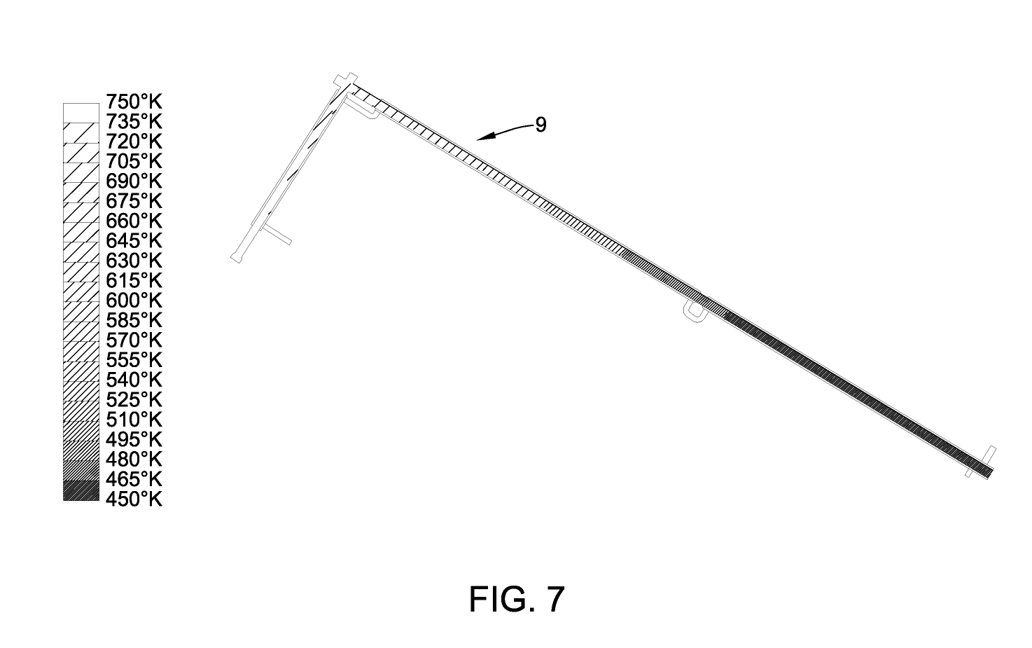

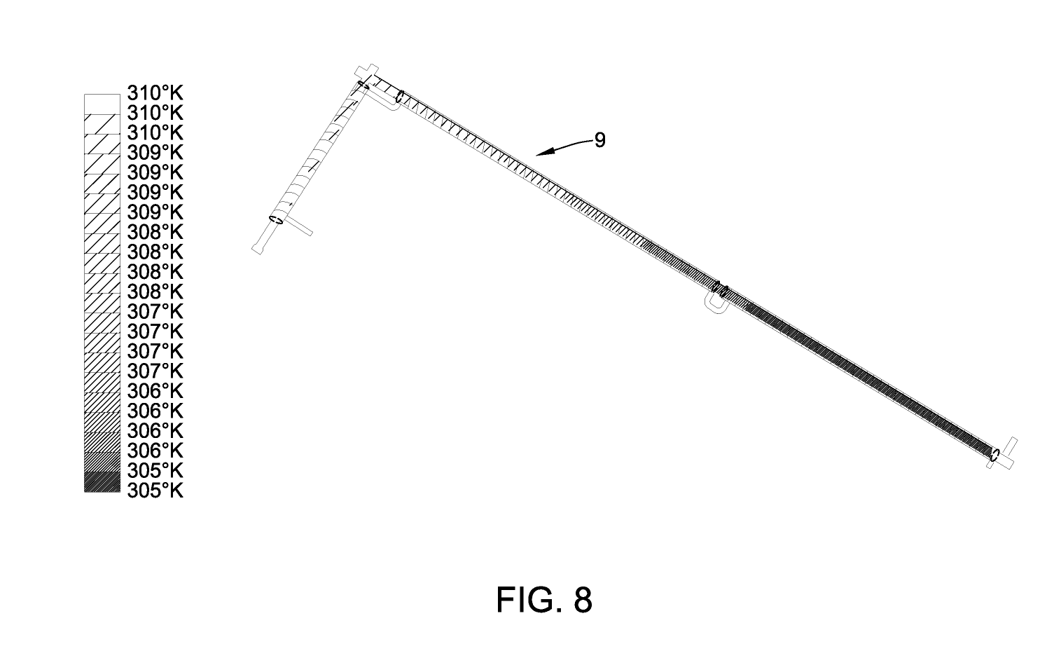

The inlet temperature of the cooling water was about 30° C. and the outlet temperature was about 38° C. The gaseous effluent entered the exchanger at about 455° C. and exited the exchanger at about 210° C. The temperature profiles for the gaseous effluent and cooling water are respectively shown in FIGS. 7 and 8.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

What is claimed is:

1. A heat exchange apparatus for transferring heat between a first process stream and a second process stream, the heat exchange apparatus comprising:
a shell;
a tube within the shell, the tube having a vertical portion and a horizontal portion transverse to the vertical portion, the shell and tube forming an annular chamber between the shell and tube; and
a baffle within the annular chamber.

2. The heat exchange apparatus as set forth in claim 1 wherein the baffle is helical.

3. The heat exchange apparatus as set forth in claim 2 wherein the helical baffle has an outer edge and an inner edge, the outer edge contacting the shell and the inner edge contacting the tube.

4. The heat exchange apparatus as set forth in claim 1 wherein the vertical portion and the horizontal portion of the tube form a joint, at least one of the vertical portion and the horizontal portion of the tube comprising a substrate and a protective liner disposed on the substrate for reducing erosion at the joint.

5. The heat exchange apparatus as set forth in claim 4 wherein the liner comprises graphite, tungsten, carbide or cobalt-chromium alloys.

6. The heat exchange apparatus as set forth in claim 1 wherein the vertical portion of the tube comprises an upper segment and a lower segment, the upper segment and lower segment being connected by an expansion joint.

7. The heat exchange apparatus as set forth in claim 1 comprising a single tube.

8. The heat exchange apparatus as set forth in claim 1 wherein the shell comprises a plurality of segments, each segment having an inlet and an outlet.

9. The heat exchange apparatus as set forth in claim 8 wherein the shell comprises a vertical segment and a horizontal segment, the horizontal portion of the tube being disposed with the horizontal segment of the shell and the vertical portion of the tube being disposed with the vertical segment of the shell.

10. The heat exchange apparatus as set forth in claim 9 wherein the horizontal portion of the tube is a first horizontal portion and the horizontal segment of the shell is a first horizontal segment, the apparatus further comprising:
a second horizontal portion of the tube, the vertical portion of the tube being disposed between the first horizontal portion and the second horizontal portion; and
a second horizontal segment of the shell, the second horizontal portion of the tube being disposed with the second horizontal segment of the shell.

11. The heat exchange apparatus as set forth in claim 8 wherein the vertical portion of the tube comprises an upper segment and a lower segment, the upper segment and lower segment being connected by an expansion joint, the shell comprising an upper vertical segment and a lower vertical segment, the upper vertical segment of the tube being disposed within the upper vertical segment of the shell and the lower vertical segment of the tube being disposed within the lower vertical segment of the shell.

12. The heat exchange apparatus as set forth in claim 1 in combination with the first process stream, the first process stream passing through the annular chamber, the first process stream comprising cooling water.

13. The heat exchange apparatus as set forth in claim 12 in combination with the second process stream, the second process stream passing through the tube, the second process stream comprising hydrogen gas.

14. The heat exchange apparatus as set forth in claim 1 wherein the vertical portion of the tube has an aspect ratio between about 70 and about 110 and the horizontal portion of the tube has an aspect ratio between about 15 and about 45.

15. The heat exchange apparatus as set forth in claim 1 wherein the vertical portion of the tube has an aspect ratio between about 80 and about 100 and the horizontal portion of the tube has an aspect ratio between about 20 and about 40.

16. A method for transferring heat between two process streams by use of the heat exchange apparatus of claim 1, the method comprising:
introducing a first process stream into the annular chamber formed between the shell and tube; and
introducing a second process stream into the tube.

17. The method as set forth in claim 16 wherein the first process stream comprises a cooling liquid.

18. The method as set forth in claim 17 wherein the second process stream comprises the effluent gas from a fluidized bed reactor for producing polycrystalline silicon.

19. The method as set forth in claim 16 wherein the first process stream and the second process stream are in a countercurrent arrangement as they pass through the heat exchange apparatus.

20. A system for producing polycrystalline silicon, the system comprising:
a fluidized bed reactor for thermally decomposing a silicon-containing compound;
the heat exchange apparatus as set forth in claim 1, the tube of the heat exchange apparatus being in fluid communication with the fluidized bed reactor;
a filter assembly for removing particulate fines from the effluent, the filter assembly being in fluid communication with the heat exchange apparatus.

21. The system as set forth in claim 20 wherein the heat exchange apparatus and fluidized bed reactor each have a height and wherein the ratio of the height of the fluidized bed reactor to the height of the heat exchange apparatus is less than about 1.5.

22. A method for producing polycrystalline silicon in the system of claim 20, the method comprising:
introducing a feed gas comprising a thermally decomposable silicon-containing compound into the fluidized bed reactor to produce polycrystalline silicon and an effluent gas;
introducing the effluent gas into the tube of the heat exchange apparatus;
circulating a cooling liquid through the annular chamber of the heat exchange apparatus, the cooling liquid and effluent gas being in a countercurrent arrangement as they pass through the heat exchange apparatus to cool the effluent gas; and
introducing the cooled effluent gas into the filter assembly.
